(19) United States
(12) Patent Application Publication
(10) Pub. No.: US 2008/0262879 A1
(43) Pub. Date: Oct. 23, 2008

(54) SHORT-TERM HOUSING RENTAL MANAGEMENT SYSTEM AND METHOD

(75) Inventors: William Barry Furlong, Seattle, WA (US); Evan Howd Gull, Seattle, WA (US); Steven Douglas Murch, Seattle, WA (US); Mengtong Yang, Issaquah, WA (US)

Correspondence Address: DAVIS WRIGHT TREMAINE, LLP/Seattle, 1201 Third Avenue, Suite 2200, SEATTLE, WA, 98101-3045, US

(73) Assignee: ESCAPIA, INC., Seattle, WA (US)

(21) Appl. No.: 11/944,572

(22) Filed: Nov. 23, 2007

Related U.S. Application Data
(60) Provisional application No. 60/867,078, filed on Nov. 22, 2006.

(51) Int. Cl. G06Q 10/00

(52) U.S. Cl. 705/5; 705/1

(57) ABSTRACT

As will be discussed in greater detail herein, a short-term housing rental management system and method provides tools for housing property managers, owners, renters, and others to better facilitate processes involved with offering and renting housing on a short-term basis. The system adds a more dynamic nature to pricing to be adaptive to changing conditions regarding such factors as timing and demand for particular short-term rental properties. Among other things, the system uses yield management to establish proper margins in rental pricing to increase returns from a rental event while seeking to increase occupancies. The system allows for short-term housing inventory to be offered simultaneously under more than one approach. For instance, the system could offer the short-term housing opportunity for a no commission approach, a merchant approach, and an agent approach.

### CROSS REFERENCE TO RELATED APPLICATION

This application claims priority benefit of provisional application Ser. No. 60/867,078 filed Nov. 22, 2006, the content of which is incorporated in its entirety.

### BACKGROUND OF THE INVENTION

Short-term housing rentals include vacation rentals, which are independently owned homes, condominiums, timeshares or other property, which are rented out to prospective guests. Often, property owners will contract with a property manager to market and rent out their vacation home. Traditionally, property owners and property managers will enter into a contract that sets marketing and pricing parameters. The property manager then markets that home, provides keys to the guests, supervises ongoing maintenance and housekeeping, and remits a portion of the proceeds back to the property owner.

Conventional approaches regarding online travel include an agent approach and a merchant approach. With an agent approach, independent lodging is sold by travel agents and other third parties who market lodging. This conventional agent approach can include a travel consumer visiting the agent and/or travel site to select the lodging. The travel consumer can provide payment information to the agent, however, the agent generally does not process payment except perhaps a small service fee.

The payment information can be passed to the lodging destination along with the reservation information. A supplier may collect a deposit from the travel consumer in stages. The travel consumer eventually arrives at the destination and stays in the property. At checkout, property management collects payment from the travel consumer. Also, at checkout, the property management pays a predetermined percentage of the collected payment to the travel agent that brought the booking to the property owner. Examples of the agent approach can be found throughout the travel industry, and online at some websites such as Expedia.com, Travelocity.com and Orbitz.com.

In contrast, a conventional merchant approach includes a merchant negotiating with suppliers regarding blocks of rental inventory at discounted prices relative to the rack rate. The merchant typically negotiates the ability to book those properties and fill them with travelers, but if there is a vacancy within X days of stay, the blocks of inventory are given back to the merchant. These blocks of rooms or lodging are pre-negotiated in advance, and assigned to the merchant for booking for some period of time. A travel consumer typically visits the merchant and chooses to book a property. The merchant sets the price on the lodging. The travel consumer pays the merchant, and often the merchant bills the entire stay up front.

The merchant then notifies the lodging supplier by fax, phone, or web that there is a guest arriving on a particular date. In some cases there may be dedicated communication lines into a property management system of a hotel or a lodging supplier to receive the information. The travel consumer travels to the property, and usually provides a credit card for incidental expenses. The travel consumer checks out (but has largely already paid for the lodging). The property management then bills the intermediary merchant for the pre-determined cost of lodging. Examples of this kind of process can be found on the “Expedia Special Rate” lodging, and Orbitz and Travelocity hotel “deals”. Hotels.com exclusively uses this type of model. The new “VacationSpot.com” uses this type of approach to sell condo-style hotels.

With these conventional approaches, scheduling, setting pricing, and otherwise managing short-term housing rentals can pose challenges that may reduce the number of actual rental events given a number of potential rental events.

### BRIEF DESCRIPTION OF THE SEVERAL VIEWS OF THE DRAWING(S)

FIG. 1 is a schematic diagram of an exemplary implementation of a computer environment that can be used with the present invention related to a practice management messaging and mining system and method.

FIG. 2 is a schematic diagram of an implementation of a short-term housing rental management system.

FIG. 3 is a schematic diagram of a short-term housing server of the system of FIG. 2.

FIG. 4 is a schematic of an interaction diagram involving components of the system of FIG. 2.

FIG. 5 is a schematic of an interaction diagram involving components of the system of FIG. 2.

FIG. 6 is a schematic of an interaction diagram involving components of the system of FIG. 2.

FIG. 7 is a flowchart of a method implemented by the system of FIG. 2.

### DETAILED DESCRIPTION OF THE INVENTION

As will be discussed in greater detail herein, a short-term housing rental management system and method provides tools for housing property managers, owners, renters, and others to better facilitate processes involved with offering and renting housing on a short-term basis such as a few days, a few weeks, or a few months. Challenges exist, which tend to reduce the number of rental bookings. For instance, there can be relatively high vacancy rates of the vacation rental housing and other short-term rentals, due to lack of awareness, static pricing, and inadequate distribution of the inventory.

The system adds a more dynamic nature to pricing to be adaptive to changing conditions regarding such factors as timing and demand for particular short-term rental properties. Among other things, the system uses yield management to establish proper margins in rental pricing to increase returns from a rental event while seeking to increase occupancies.

For instance, the system allows property managers to be able to opt into a program, by checking one or more boxes on a web-based browser or other data network communication device, to define triggers for pricing. The system utilizes this information to market the inventory at some cost of goods sold and resell it without inherent delays.

The system allows for short-term housing inventory to be offered simultaneously under more than one approach. For instance, the system could offer the short-term housing opportunity for a no commission approach, a merchant approach, and an agent approach. The no commission approach could include where a customer was brought into a private labeled website of the property owner hosted by the system. The merchant approach could include where a customer would deal directly through destination websites of the system, other distribution pipelines to the system, and management staff overseeing the system. The agent approach involves an agency representing the short-term housing property with a private label website of the agency supported by the system. Through these various approaches demand can be created and resultant rentals can be handled both through destination sites and other sorts of sites on the Internet.

The system involves, in part, information regarding an inventory of property for use as short-term rental housing. The system uses operational rules defined for each property by either a manager of the property or another person. The operational rules generally include constraints that are established by a merchant or another. For instance, a property manager might stipulate a condition that requires a reservation be placed such that for a particular reservation on properties X, Y, and Z, within 21 days of an occupancy in which no other booking attempts have occurred, a particular rental fee would apply or some constraint, such as a 7 night minimum, could be removed.

The operational rules could involve such aspects as the conditions to allocate a particular property to a designated inventory available to be rented, or classes of property that could be rented, or the rental fees or income permitted by a manager for a particular property or class of properties.

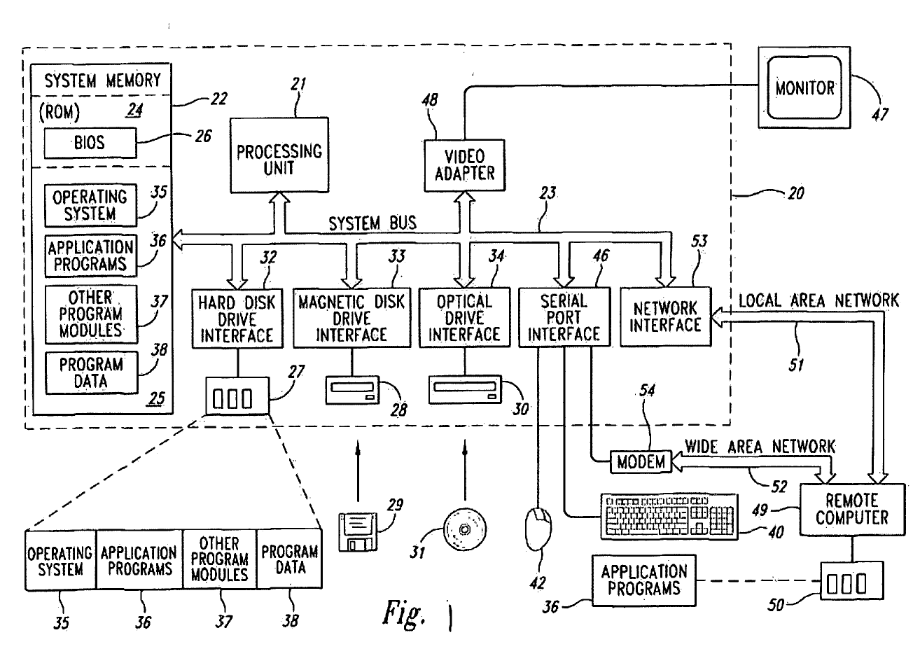

An exemplary hardware and operating environment of FIG. 1 includes a general purpose computing device in the form of a computer 20, including a processing unit 21, a system memory 22, and a system bus 23 that operatively couples various system components, including the system memory 22, to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20, the local computer; implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 1. The logical connections depicted in FIG. 1 include a local-area network (LAN) 51 and a wide-area network (WAN) 52. Such networking environments are commonplace in offices, enterprise-wide computer networks, intranets and the Internet.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

The hardware and operating environment in conjunction with implementations that may be practiced has been described. The computer in conjunction with implementation that may be practiced may be a conventional computer, a distributed computer, or any other type of computer. Such a computer typically includes one or more processing units as its processor, and a computer-readable medium such as a memory. The computer may also include a communications device such as a network adapter or a modem, so that it is able to communicatively couple to other computers.

An implementation of the system 100 is shown in FIG. 1 as having a renter communication device 102 for use by potential renters of short-term housing, an agency communication device 104 for use by agencies that represent the short-term housing, and an owner communication device 106 for use by owners that own the short-term housing. The renter communication device 102, the agency communication device 104, and the owner communication device 106 can be browser based computers and/or mobile devices that can support user interfaces to communicate with servers, such as a short-term housing server or an intermediary server 110 or other information storage machines through a data network 112 such as the Internet, cellular network or other network. The renter communication device 102, the agency communication device 104, and the owner communication device 106 can allow renters, agencies, or owners, respectively, to obtain information regarding availability, location, accommodations, pricing, bargains, requirements and other information about short-term rental housing. The renter communication device 102, the agency communication device 104, and/or the owner communication device 106 may allow various users to send other sorts of inquiries, requests, or other sorts of communication via e-mail or other types of communication through the system 100.

The renter communication device 102 can allow renters to book one or more instances of rentals, modify earlier booked rentals, or otherwise check status of short-term rental housing. The agency communication device 104, and the owner communication device 106 can allow agencies and owners, respectively, to check status of their rentals, to change rules that determine pricing, and to add, delete, or otherwise modify information concerning a short-term housing rental.

The system 100 further includes the short-term housing server 108 that supports management of the short-term housing involving such functions as inventory tracking, reservation establishment, communication, accounting, and other services. The short-term housing server 108 may receive some direct communication with the renter communication devices 102 and will generally receive communication from the agency communication devices 104 and owner communication devices 106 to generally serve renters, agencies, and owners in various functions described.

The system 100 can have the intermediary servers 110, as depicted, that can receive communication from the renter communication device 102, the agency communication device 104, and the owner communication device 106 and further communicate and pass off messages and other information to the short-term housing server 108. The intermediary servers 110 can host various web pages to serve marketing functions for various entities including vertical vacation rental directory pages, horizontal directory pages, niche content pages, and search engines. The vertical vacation rental directory pages could serve such Internet entities as HomeAway.com, VacationHomeRentals.com, and BeachHouse.com.

The horizontal directory pages could include such Internet entities as Expedia, Orbitz, or Priceline. The niche content pages could include such Internet entities as Golf Digest. The search engines could include such Internet entities as Google, Ask Jeeves, Dog Pile, Yahoo, MSN, etc. The intermediary servers 110 can be separate or part of the short-term housing server 108. The intermediary servers 110 have couplers 114 that allow communication received from the renter communication device 102, the agency communication device 104, and the owner communication device 106 to be processed and redirected to the short-term housing server 108 for further processing and follow-up responses either sent directly from the short-term housing server 108 or routed through the intermediary servers 110 to the renter communication device 102, the agency communication device 104, and the owner communication device 106. In some implementations, the intermediary servers 110 have a form of the coupler 114 that uses one or more application program interfaces to help with integrating communication with the short-term housing server 108. For instance, the intermediary server 110 may establish an XML feed of information to the short-term housing server 108 through application program interfaces.

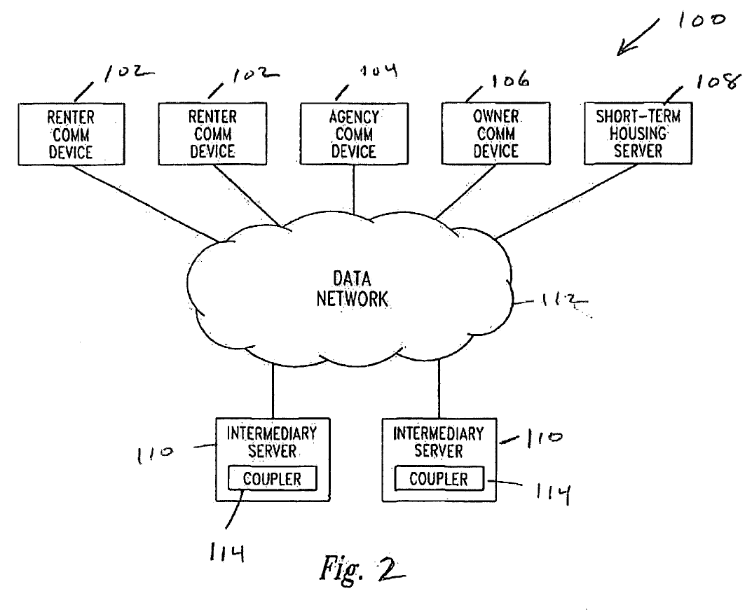

As further depicted in FIG. 2, the short-term housing server 108 can include components such as a coupler communication module 116, a database module 118, a pricing module 120, a reservations module 122, a correspondence module 124, an accounting module 126, and a private labeling module 128. The coupler communication module 116 helps to communicate with the intermediary servers 110 and also with the renter communication device 102, the agency communication device 104, and the owner communication device 106 either directly or through the intermediary servers through such mechanisms as application program interfaces. The database module 118 stores information regarding short-term housing inventory, reservations, scheduling, pricing, and other information used in the system 100. The reservations module 122 is used for booking of short-term housing and other functions to support scheduling and reservation activities. The correspondence module 124 can provide e-mail, chat, or other functions to send and receive messages through the system 100. The accounting module 126 supports accounting functions regarding the various short-term housing properties with the many various owners possible. The private labeling module 128 can furnish tailored web pages for individual owners or agencies to provide additional avenues for marketing of the short-term housing inventory.

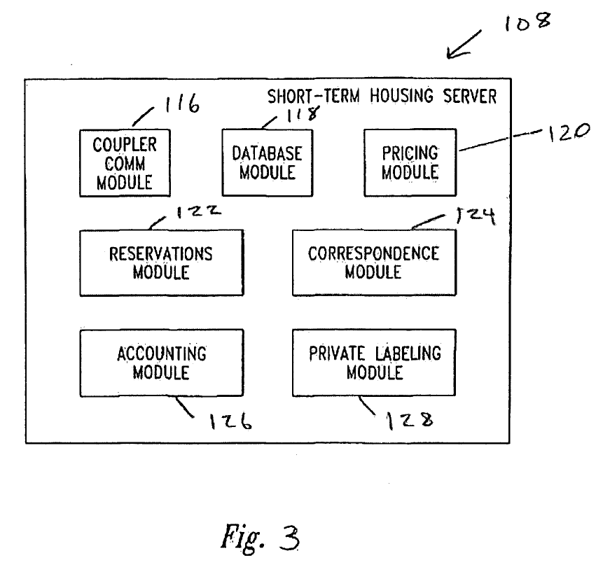

Representative instances of communication 130 are depicted in FIG. 3 including the renter communication device 102 sending a first query/command 132 to the intermediary sever 110, which passes the first query/command on to the short-term housing server 108. The short-term housing server 108 then processes 134 the received first query/command 132 and sends a first response 136 directly to the renter communication device 102. A second query/command 138 sent from the renter communication device 102, after processing 140 by the short-term housing server 108, is depicted as being responded to by a second response 142 passed on from an intermediary server 110. A third query/command 144 is sent directly from the renter communication device 102 to the short-term housing server 108 and after processing by the short-term housing server 108, a third response is sent directly from the short-term housing server to the renter communication device.

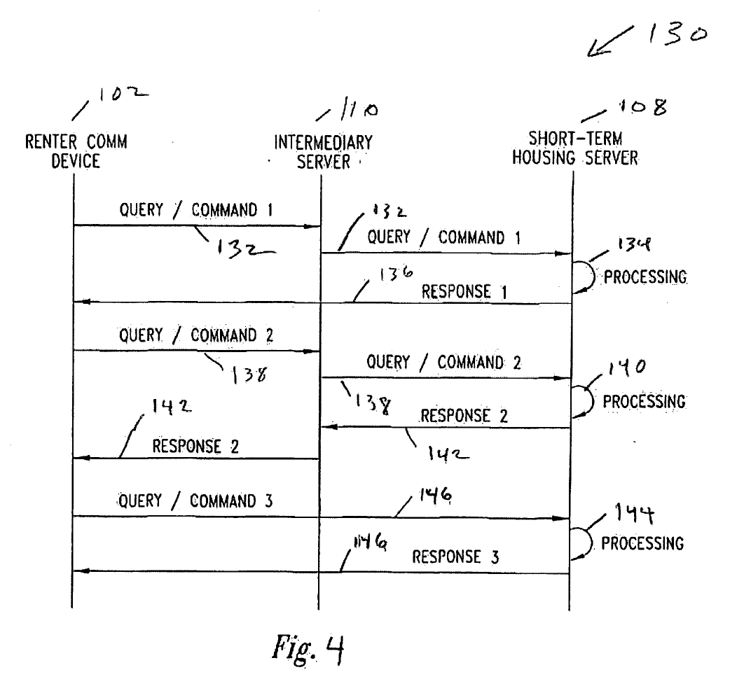

As depicted by interactions 150 in FIG. 4, the owner communication device 106 can send a query/command 152 directly to the short-term housing server 108, which processes such and send a response 154 directly to the owner communication device.

For instance, in some implementations of the interactions 150, information is provided about the availability of one or more short-term rental housings during a date range requested by the owner communication device 106 in the query/command 152 to the short-term housing server 106. The short-term housing server 108 receives the described date range request version of the query/command 152 and evaluates whether any of the days in the requested date range already have bookings, such as being received through requests from others of the renter communication device 102, the agency communication device 104, or through input to the short-term housing server from property management staff (such as from the property management staff receiving a phone call directly from a potential renter) under the merchant model. In some implementations, if the date range request version of the query/command 152 is for any units that meet a set of pre-defined criteria, the one or more short-term rental housings will not be included as being indicated to the owner communication device 106 as being one of the rentals units that are available during the date range. If the date range request version of the query/command 152 is for individual short-term rental housing, the short-term housing server will return a response 154 that the short-term rental housing is not available for the requested dates.

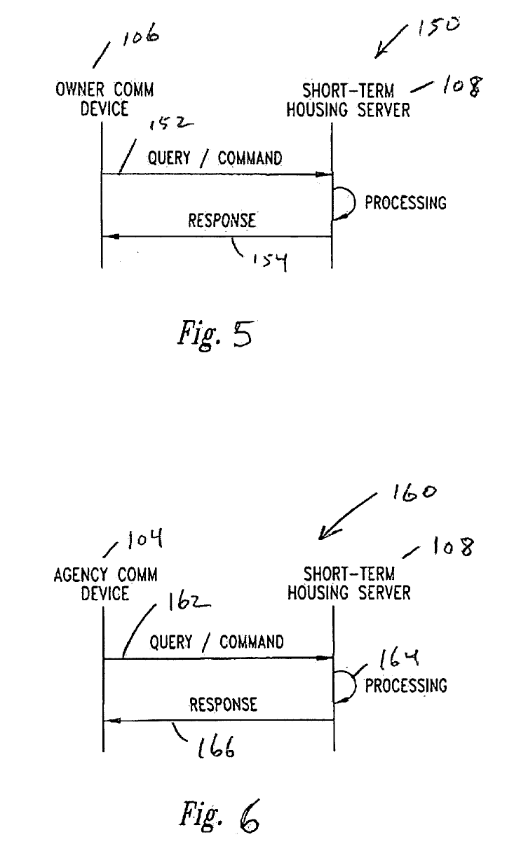

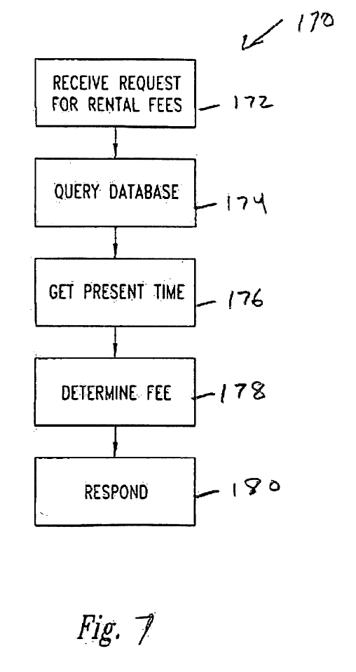

As depicted by interactions 160 in FIG. 5, the agency communication device 104 can send a query/command 162 directly to the short-term housing server 108, which processes 164 such and sends a response 166 directly to the agency communication device.

A method 170 to be used with the pricing module 120 of the short-term housing server 108 is depicted in FIG. 6 as receiving a request for rental fees regarding a short-term rental housing (step 172) from various websites, such as through the intermediary server 110, and/or various devices, such as through the renter communication device 102. The request for rental fees (step 172) can be received from various websites through the database module 118 is queried to obtain baseline parameters and rules for establishing price (step 174). A present date is obtained from a system clock (step 176), such as from the system clock of the short-term housing server 108. The method determines a current price for the short-term rental housing (step 178) based upon the baseline parameters and rules, current date and other information either obtained from the database module or a request/command sent by a renter communication device.

The short-term housing server 108 responds (step 180) with a determined price. In implementations a set of rules will be established (for instance, by a pertinent agency involved) that govern what prices are returned in the response for step 180. Pricing may depend on the timing of the request, the number of travelers, the overall occupancy rates, the date ranges for the request, the length of the stay and other criteria.

If no information is received by the short-term housing server 108 for the date of the reservation or other criteria on which the precise pricing depends, the method 170 will then return in step 180 a range of pricing that represent the high and low ends of the possible pricing range. The short-term housing server 108 will invite the consumer to provide additional information required to provide an exact price quote.

What price is displayed depending on whether the merchant model is involved in which the request of step 172 to the short-term housing server 108 is received directly from management staff of the short-term rental housing or whether the agent model is involved, in which the request of step 172 to the short-term housing server 108 is received through the agency communication device 104. If the agent model is involved, the pricing will typically be determined by the pricing module 120 of the short-term housing server 108. If the merchant model is involved, the property management staff so requesting may have the option to choose to adjust the price either higher or lower than that provided by the pricing module 120. In the case where the merchant model is involved, the pricing module 120 may return information that tells the requester the allowable range of retail pricing for that reservation.

Parameters and rules used to determine pricing can include various indicators related to supply and demand for a particular property or properties in a particular area and the particular timing of a reservations request. For instance, if a particular property has had no recent request history, pricing may be lowered. If timing involves a local popular event, pricing may be increased. If timing is such that the reservations request is near time when the housing will be used, pricing may be lowered to insure a reservation or may be increased if general availability of inventory is very low.

If the response received in step 180 allows for a booking, under the agent model, the agency communication device 104 and under the merchant model, the short-term housing server 108 can send a confirmed booking to the renter communication device 102 that originated the request (or alternatively under the merchant model a property management staff can use an alternative communication device, such as a phone, if the renter communication device 102 was not used to initially submit a request. Once pricing is provided and indication is made to the prospective renter that the short-term housing rental is available for the requested date, the prospective renter can provide their name, contact information and payment information to the short-term housing server 108 through the renter communication device 102 thereby confirming the reservation to the short-term housing server. Upon receipt of the reservation confirmation, the booking request is sent to the reservations module 122 of the short-term housing server 108 either directly if the renter has made direct contact with the property management staff or through the intermediary server 110 if the renter has made contact through such an alternative means.

The reservations module 122 will forward indication of the booking for the particular dates to the database module 118 thereby preventing a double booking of the short-term housing rental for a second party for the same dates already reserved. In the merchant model, payment information will be kept by the communication device originating the request. In the agency model, the payment information will be transmitted to the property manager to process payment.

Integration with the other modules of the short-term housing server 108 allows for consistency in processing of all bookings by the short-term housing rental property management regardless of what route the bookings were received. The correspondence module 124 or other alternative communication modules of the short-term housing server 108 is used for ongoing communication with the renter. The accounting module 126 is used to ensure that the transactions are appropriately handled in the managers financial books. The short-term housing server 108 can have other modules as well including housekeeping and front desk modules that can be engaged to ensure that the short-term rental housing is ready for arrival of guests, which can be recorded by the agency's front desk.

In one or more various implementations, related systems include but are not limited to circuitry and/or programming for effecting the foregoing-referenced method implementations; the circuitry and/or programming can be virtually any combination of hardware, software, and/or firmware configured to effect the foregoing-referenced method implementations depending upon the design choices of the system designer.

The foregoing provides exemplary descriptions and thus contains, by necessity; simplifications, generalizations and omissions of detail; consequently, those skilled in the art will appreciate that the summary is illustrative only and is not intended to be in any way limiting. Those having ordinary skill in the art will recognize that the environment depicted has been kept simple for sake of conceptual clarity, and hence is not intended to be limiting.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will appreciate that there are various vehicles by which processes and/or systems described herein can be effected (e.g., hardware, software, and/or firmware), and that the preferred vehicle will vary with the context in which the processes are deployed.

For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The foregoing detailed description has set forth various embodiments of the devices and/or processes via the use of block diagrams, flowcharts, and examples. Insofar as such block diagrams, flowcharts, and examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof.

Those skilled in the art will recognize that the embodiments disclosed herein, in whole or in part, can be equivalently implemented in standard or custom Integrated circuits, as one or more computer programs running on one or more computers (e.g., as one or more programs running on one or more data processing systems), as one or more programs running on one or more controllers (e.g., microcontrollers) as one or more programs running on one or more processors e.g., microprocessors, as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms of the present invention are capable of being distributed as a program product in a variety of forms, and that an illustrative implementation of the present invention applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analogue communication links using TDM or IP based communication links (e.g., packet links).

In a general sense, those skilled in the art will recognize that the various implementations described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into data processing systems. That is, the devices and/or processes described herein can be integrated into a data processing system via a reasonable amount of experimentation.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

From the foregoing it will be appreciated that, although specific embodiments of the invention have been described herein for purposes of illustration, various modifications may be made without deviating from the spirit and scope of the invention. Accordingly, the invention is not limited except as by the appended claims.

The invention claimed is:

1. For an owner of a short-term rental housing, a property manager of the short-term rental housing, an agent of an agency, and a potential renter of the short-term rental housing, a method comprising:
providing access for the owner of the short-term rental housing to a short-term housing rental management system to allow the owner to query the system regarding short-term rental availability of the short-term rental housing;
providing access for the property manager of the short-term rental housing to the short-term housing rental management system to allow the property manager to query the system regarding short-term rental availability of the short-term rental housing;
providing access for the agent of the rental agency to the short-term housing rental management system to allow the agent to query the system regarding short-term rental availability of the short-term rental housing; and
providing access for the potential renter of the short-term rental housing to the short-term housing rental management system to allow the owner to query the system regarding short-term rental availability of the short-term rental housing.

2. The method of claim 1 wherein providing access includes providing access to information regarding at least one of short-term rental housing inventory, reservations, scheduling, and pricing.

3. The method of claim 1 wherein the short-term rental housing is a house.

4. The method of claim 1 wherein the short-term rental housing has a rental period of less than at least one of the following: a week, a month, and a quarter.

5. The method of claim 1 wherein the potential renter is directed to the short-term housing rental management system through an intermediary server

6. The method of claim 5 wherein the intermediary server hosts web pages to serve at least one of the following: vertical vacation rental directory pages, horizontal vacation rental directory pages, niche content pages, and search engines

7. The method of claim 6 wherein the vertical rental directory pages includes at least one of the following: HomeAway.com, VacationHomeRentals.com, and BeachHouse.com.

8. The method of claim 6 wherein the horizontal vacation rental directory pages includes at least one of the following: Expedia, Orbitz, and Priceline.

9. The method of claim 6 wherein the niche content pages includes GolfDigest.

10. The method of claim 6 wherein the search engines include at least one of the following: Google, Ask Jeeves, Dog Pile, Yahoo, MSN.

11. The method of claim 1 wherein the potential renter is directed to the short-term rental housing system through a private label website funded at least in part by the owner of the short-term rental housing.

12. The method of claim 1 wherein the potential renter is directed to the short-term rental housing system through a destination website of the short-term rental housing system.

13. The method of claim 1 wherein the potential renter is directed to the short-term rental housing system through property management staff overseeing the short-term rental housing system.

14. The method of claim 1 wherein the short-term rental housing includes an inventory of houses.

15. For an owner of a short-term rental housing, a property manager of the short-term rental housing, an agent of rental agency, and a third party a method comprising:
providing access to receive a reservation request for one of a short-term housing rental inventory by a reservations module of a short-term housing rental management system through a website of the short-term housing rental management system, the website being funded at least in part by an owner of the short-term housing rental;
providing access to receive a reservation request for one of the short-term housing rental inventory to a reservations module of the short-term housing rental management system through a website of the short-term housing rental management system, the website being funded at least in part by an travel agency;
providing access to receive a reservation request for one of the short-term housing rental to a reservations module of the short-term housing rental management system through a website of the short-term housing rental management system, the website being funded at least in part by a property manager of the third short-term housing rental; and
providing access to receive a reservation request for one of the short-term housing rental to a reservations module of a short-term housing rental management system through a website on an intermediary to the short-term housing rental management system, the website funded at least in part by the third party.

16. The method of claim 1 further including determining a rental price based on a date of receiving the reservation request.

17. The method of claim 1 further including providing a response to receipt of a reservation request based at least in part on whether a predefined number of days before occupancy are present in which no other booking attempts have occurred.

18. The method of claim 17 wherein the response includes removal of a minimum night restriction on the reservation.

19. The method of claim 15 further including providing a response to receipt of a reservation request based at least in part on rules defining what class of property could be rented.

20. The method of claim 15 further including providing a response to receipt of a reservation request based at least in part on income permitted by the property manager.

21. The method of claim 15 wherein the short-term rental housing includes an inventory of houses.

22. A method comprising:
receiving via a network an inquiry regarding a short-term rental housing;
querying a database to obtain information for establishing a rental price for the short-term rental housing;
determining a present time;
determining a rental price for the short-term rental housing based upon the present time and the information from the database; and
responding to the inquiry with the determined rental price for the short-term rental housing.

23. The method of claim 22 wherein the information includes baseline parameters and rules

24. The method of claim 22 wherein the information includes triggers for pricing defined by a property manager of the short-term rental housing.

25. The method of claim 22 wherein the information is based at least in part on yield management to establish margins in pricing.

26. The method of claim 22 wherein the information at least in part instructs a property manager of the short-term rental housing how to opt into a program related to the rental price of the short-term rental housing.
